(19) United States
(12) Patent Application Publication
(10) Pub. No.: US 2015/0127257 A1
(43) Pub. Date: May 7, 2015

(54) SYSTEM AND METHOD FOR VEHICLE LIFE LOGGING AND SEARCHING

(71) Applicant: Honda Motor Co. Ltd., Tokyo (JP)

(72) Inventors: Fuminobu Kurosawa, San Jose, CA (US); Daniel Essindi Behrendt, Atherton, CA (US)

(73) Assignee: Honda Motor Co. Ltd., Tokyo (JP)

(21) Appl. No.: 14/069,836

(22) Filed: Nov. 1, 2013

(51) Int. Cl. G01C 21/26; G06F 17/30

(52) U.S. Cl. CPC G01C 21/26; G06F 17/30424
USPC 701/538

(57) ABSTRACT

A vehicle computer implemented method and system for life logging and searching in a vehicle including receiving a request for a vehicle life moment from a vehicle occupant in the vehicle and determining a vehicle life moment from a data store based on the request. The determining includes extracting one of a temporal data component or an activity data component from the request. Further, the method and system include providing the vehicle life moment to the vehicle occupant.

### BACKGROUND

Many memorable experiences can be created with a vehicle or while driving a vehicle. Sophisticated vehicle computing systems can provide information and context about these experiences and interactions with the vehicle. The experiences can be further supported by other types of data and maintained to provide a complete picture of vehicle life.

### BRIEF DESCRIPTION

According to one aspect, a vehicle computer implemented method for life logging and searching in a vehicle includes receiving a request from a vehicle occupant in the vehicle and determining the vehicle life moment from a data store based on the request. The method also includes identifying one of a temporal data component, a subject data component or an activity data component from the request and providing the vehicle life moment to the vehicle occupant.

According to another aspect, a vehicle computing system for life logging and searching in a vehicle includes a data store communicatively coupled to a processor. The processor includes a life logging determination module and a life logging input and output module. The life logging determination module is configured to receive a request from a vehicle occupant in the vehicle and determine a vehicle life moment from a data store based on the request. The determining includes identifying one of a temporal data component, a subject data component or an activity data component from the request. The life logging input and output module is configured to provide the vehicle life moment to the vehicle occupant via an output device.

According to a further aspect, a non-transitory computer-readable storage medium storing instructions that, when executed by a vehicle computer, causes the computer to perform the steps of receiving a request from a vehicle occupant in the vehicle, and determining a vehicle life moment from a data store based on the request, wherein the determining includes identifying one of a temporal data component, a subject data component or an activity data component from the request. The steps also include providing the vehicle life moment to the vehicle occupant.

### BRIEF DESCRIPTION OF THE DRAWINGS

FIG. 1 is a schematic view of an illustrative system for vehicle life logging and searching according to one exemplary embodiment;

FIG. 2 is a schematic view of an illustrative processor of the system of FIG. 1; and

FIG. 3 is a flow chart illustrating a method for vehicle life logging and searching according to one exemplary embodiment.

### DETAILED DESCRIPTION

The embodiments describe herein include definitions of selected terms employed herein. The definitions include various examples and/or forms of components that fall within the scope of a term and that can be used for implementation. The examples are not intended to be limiting. Further, one having ordinary skill in the art will appreciate that the components discussed herein, can be combined, omitted or organized with other components or into organized into different architectures.

A “bus”, as used herein, refers to an interconnected architecture that is operably connected to other computer components inside a computer or between computers. The bus can transfer data between the computer components. The bus can be a memory bus, a memory controller, a peripheral bus, an external bus, a crossbar switch, and/or a local bus, among others. The bus can also be a vehicle bus that interconnects components inside a vehicle using protocols such as Controller Area network (CAN), Local Interconnect Network (LIN), among others.

“Computer communication”, as used herein, refers to a communication between two or more computing devices (e.g., computer, personal digital assistant, cellular telephone, network device) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “data store”, as used herein can refer to table, a set of tables, a set of data bases and/or methods for accessing and/or manipulating those data bases.

A “disk”, as used herein can be, for example, a magnetic disk drive, a solid state disk drive, a floppy disk drive, a tape drive, a Zip drive, a flash memory card, and/or a memory stick. Furthermore, the disk can be a CD-ROM (compact disk ROM), a CD recordable drive (CD-R drive), a CD rewritable drive (CD-RW drive), and/or a digital video ROM drive (DVD ROM). The disk can store an operating system that controls or allocates resources of a computing device.

A “memory”, as used herein can include volatile memory and/or nonvolatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory can store an operating system that controls or allocates resources of a computing device.

A “module”, as used herein, includes, but is not limited to, hardware, firmware, software in execution on a machine, and/or combinations of each to perform a function(s) or an action(s), and/or to cause a function or action from another module, method, and/or system. A module can include a software controlled microprocessor, a discrete logic circuit, an analog circuit, a digital circuit, a programmed logic device, a memory device containing executing instructions, and so on.

An “operable connection”, or a connection by which entities are “operably connected”, is one in which signals, physical communications, and/or logical communications can be sent and/or received. An operable connection can include a physical interface, a data interface and/or an electrical interface.

A “processor”, as used herein, processes signals and performs general computing and arithmetic functions. Signals processed by the processor can include digital signals, data signals, computer instructions, processor instructions, messages, a bit, a bit stream, or other means that can be received, transmitted and/or detected. Generally, the processor can be a variety of various processors including multiple single and multicore processors and co-processors and other multiple single and multicore processor and co-processor architectures. The processor can include various modules to execute various functions.

A “portable device”, as used herein, is a computing device typically having a display screen with user input (e.g., touch, keyboard) and a processor for computing. Portable devices include, but are not limited to, handheld devices, mobile devices, smart phones, laptops, tablets and e-readers.

A “vehicle”, as used herein, refers to any moving vehicle that is capable of carrying one or more human occupants and is powered by any form of energy. The term “vehicle” includes, but is not limited to: cars, trucks, vans, minivan.

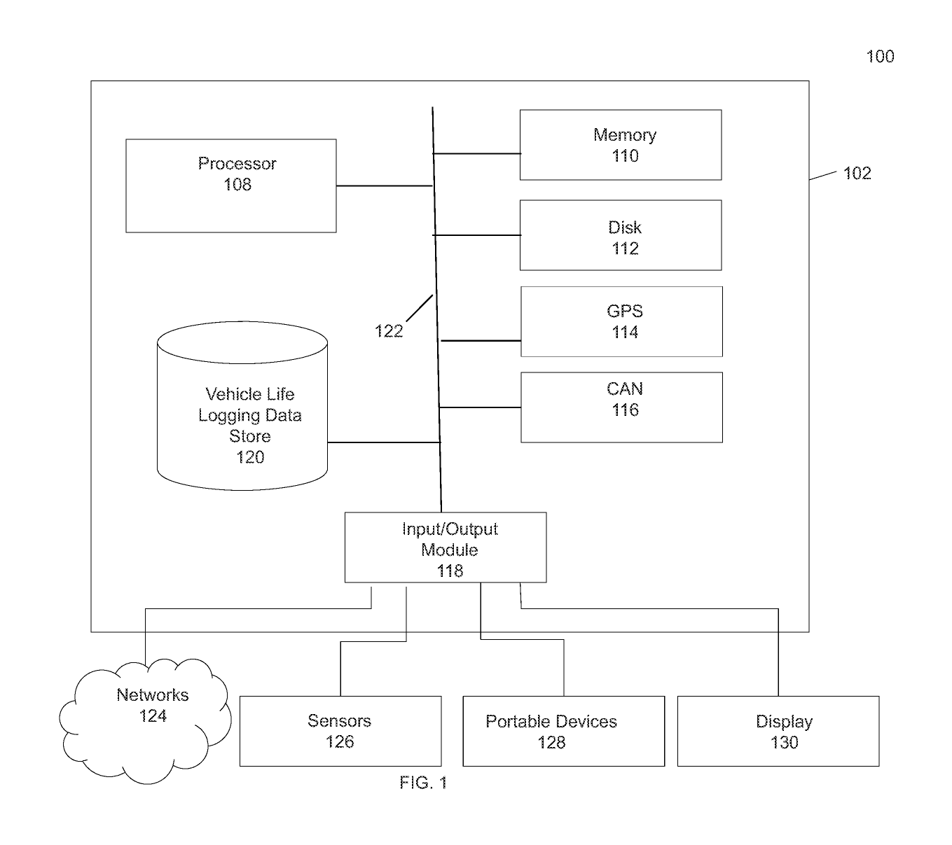

Referring now to the drawings, wherein the showings are for purposes of illustrating one or more exemplary embodiments and not for purposes of limiting same, FIG. 1 illustrates a system 100 for vehicle life logging and searching. The system 100 illustrated in FIG. 1 can be implemented alone or in combination with a vehicle computing device 102 (e.g., a navigation system, an infotainment system, a portable device, etc.) located or associated with a vehicle (not shown). The components of system 100, as well as the components of other systems and architectures discussed herein, can be combined, omitted or organized into different architectures for various embodiments.

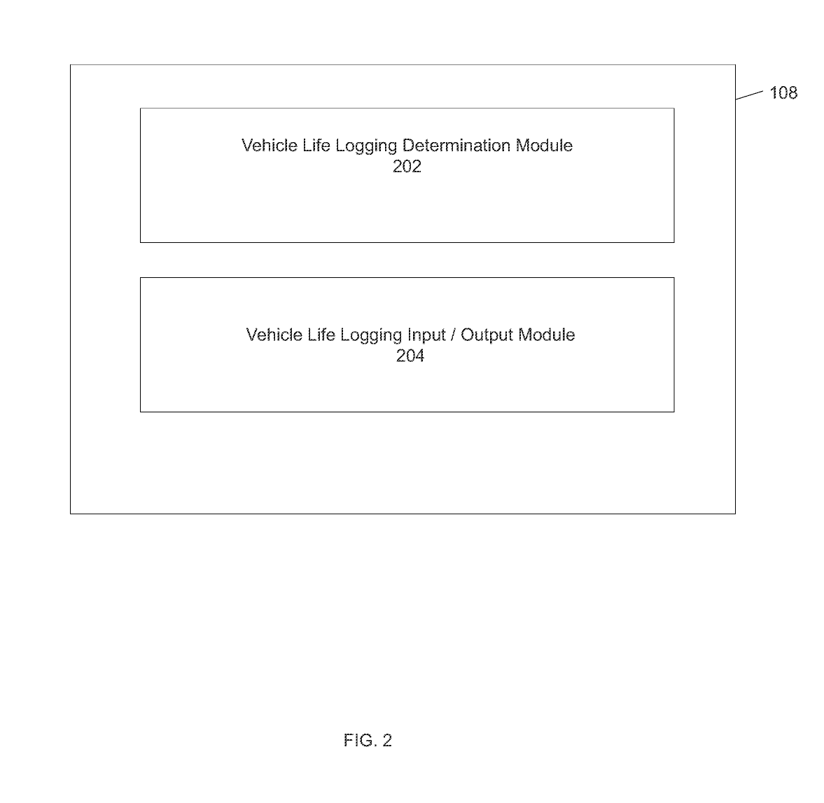

In the illustrated embodiment shown in FIG. 1, the vehicle computing device 102 includes a processor 108, a memory 110, a disk 112, a global positioning system (GPS) 114, a Controller Area Network (CAN) 116 and an input/output (I/O) module 118. The processor 108 provides functionality to facilitate vehicle life logging and searching, which will be discussed in further detail herein with reference to FIG. 2. Additionally, the vehicle computing device 102 includes a vehicle life logging data store 120 that can store personal and non-personal data from more than one data source. The components of system 100 and the vehicle computing system 104 can be operably connected for computer communication via a bus 122 and/or other known wired and wireless technologies.

The vehicle computing system can be operably connected for computer communication to other networks (e.g., a vehicle network, the Internet, a cellular network) and other data sources internal and external to the vehicle. For example, the vehicle computing system 102 can communicate with a network 124, a plurality of sensors 126 and/or a plurality of portable devices 128. The I/O module 118 facilitates data input and output between the components of the vehicle computing device 102 and other data sources, for example, the networks 124, the sensors 136 and the portable devices 128. The sensors can be vehicle sensors, environment sensors or sensors associated with one of the portable devices 128. The system 100 can include any type of sensors known for monitoring and sensing vehicle data and multimodal interaction data associated with vehicle occupants in the vehicle. Data from these various sources can be accessed, monitored and/or transferred to the vehicle computing device 102 to support vehicle life logging and searching functions. Further, other components of the vehicle computing device 102 (e.g., the GPS 114, the CAN 116) can also include sensors or have sensor functionality as described herein.

The I/O module 118 also facilitates data input and output between the vehicle computing device 102 and a display 130. The display 130 can be a human machine interface (HMI) with hardware and software for proving vehicle occupant input and output. In one embodiment discussed herein, the display 130 can provide an interface for searching and providing vehicle life moment records to a vehicle occupant. The portable device 128 can also be utilized alone or in combination with the display 130 for providing vehicle occupant input and output.

Referring now to FIG. 2, exemplary system architecture of the processor 108 of FIG. 1 will now be discussed. The processor 108 includes a vehicle life logging determination module 202 and a vehicle life logging input/output (I/O) module 204. The components and functions of the processor 108, can be combined, omitted or organized into different architectures for various embodiments. In the illustrated embodiment of FIG. 2, the vehicle life logging determination module 202 is configured to receive a request from a vehicle occupant in the vehicle. The request can include a query for a past event (i.e., a vehicle life moment) associated with the vehicle and/or the vehicle occupant. The request can be received via user input from the vehicle occupant and includes, but is not limited to, speech input, gesture input, text input and/or touch input. For example, the sensors 126 can include audio sensors for detecting speech input from the vehicle occupant. The input/output module facilitates transfer of the speech input data from the sensors 126 to the processor 108 for further processing by the vehicle life logging determination module 202. The processor 108 can also include speech and gesture recognition modules (not shown).

In response to the request, the vehicle life logging determination module 202 is further configured to determine a vehicle life moment from a data store 120 based on the request. The data store 120 includes personal data related to the vehicle occupant and/or the vehicle occupant and the vehicle. The personal data can include, for example, data about a vehicle occupant's routine, habits, appointments, calendar, social data and media data. The personal data can come from more than one data source, for example, via an application on the portable device 128, a network 124, the GPS 114 or the CAN 116, among others.

The data store 120 also includes non-personal data related to the vehicle and other environmental conditions not directly associated with the vehicle occupant. The non-personal data can include, but is not limited to, vehicle location data, vehicle diagnostic data, data about one or more vehicle systems, vehicle sensor data, environment data and weather data. The non-personal data can also come from more than one data source, for example, via an application on the portable device 128, a network 124, the GPS 114 or the CAN 116, among others.

As discussed above, the personal and non-personal data is acquired or received from more than one data source. The data sources can include, but are not limited to, the GPS 114, the CAN 116, the networks 124, the sensors 126, the portable devices 128, applications executed by the vehicle computing device 102 and/or the portable devices 128 and the display 130. Table 1 below lists exemplary types of personal data, non-personal data and data sources in relation to the exemplary system 100 of FIG. 1.

TABLE 1

| Personal Data | | Non-Personal Data | |
|---|---|---|---|
| Type | Source | Type | Source |
| Driving | CAN 116; sensors | Driving | CAN 116; Sensors |
| Patterns | 126 | Patterns | 126 |
| Music | CAN 116; | Demographics, | the portable |
| | infotainment | Statistics | devices 128 (e.g., |
| | system (e.g., | | applications); |
| | vehicle computing | | Network 124 |
| | device 102); | | |
| | portable devices | | |
| | 128 (e.g., music | | |
| | applications) | | |
| Buying | portable devices | Weather | the portable |
| Patterns | 128 (e.g., | | devices 128 (e.g., |
| | applications); | | applications); |
| | Network 124 | | Network 124 |
| Email/ | portable devices | Sports | the portable |
| Calendar | 128 (e.g., | | devices 128 (e.g., |
| | applications); | | applications); |
| | Network 124 | | Network 124 |
| Social Media | the portable | Traffic | portable devices |
| | devices 128 (e.g., | | 128; Network 124 |
| | applications); | | |
| | Network 124 | | |
| Points of | GPS 114, portable | Points of | GPS 114; the |
| Interest | devices 128 (e.g., | Interest | portable devices |
| | applications); | | 128 (e.g., |
| | Network 124 | | applications); |
| | | | Network 124 |

In one exemplary embodiment, the vehicle life logging determination module 202 is also configured to receive the personal and non-personal data from the more than one data source and store the personal and non-personal data in the data store 120. The personal and non-personal data can be received and stored continuously when the vehicle in is in an active state (e.g., ignition ON signal). In another embodiment, the vehicle life logging determination module 202 can generate a vehicle life moment record based on the personal data, the non-personal data and a predetermined condition. In one embodiment, the predetermined condition is stored at the data store 120. The predetermined condition can be based on user preferences previously defined by the vehicle occupant. For example, a vehicle life moment record can automatically be generated upon reaching a destination, playing a new song in the vehicle, at a mileage milestone, among others. Therefore, the vehicle life moment record provides a “snapshot” of the state of vehicle occupant and the vehicle at a particular moment based on the personal data and the non-personal data.

The vehicle life logging determination module 202 is also configured to identify at least one of a temporal data component, a subject data component or an activity data component from the request. In one embodiment, the vehicle life logging determination module 202 is configured to identify the temporal data component and the subject data component from the request. In another embodiment, the vehicle life logging determination module 202 is configured to identify the temporal data component, the subject data component and the activity data component from the request. The identification of the temporal data component, the subject data component and/or the action data component can be executed in parallel with any input recognition processes (e.g., speech recognition, gesture recognition). Further, there may be more than on temporal data component, subject data component and/or action data component in each request.

A temporal data component can include a time, a day, a week, a month, a year (e.g., a timestamp) associated with the activity data component. As an illustrative example, a request for a vehicle life moment can be obtained as a speech input from a vehicle occupant as “Do you remember a nice bridge while driving in the rain last year?” The vehicle life logging determination module 202 identifies the temporal data component as “last year.” The temporal data component can be converted to a date format in order to query the data store 120. For example, the vehicle life logging determination module 202 can calculate a numeric date from the temporal data component (i.e., “last year”) and the current year.

The subject data component can include data describing the subject of the vehicle life moment. In one example, the subject is the focus of the vehicle occupant's request. In other words, the subject can be the “what or whom” of the request. For example, the subject can be a location, a media file, a data file, among others. Referring again to the illustrative example above, the vehicle life logging determination module 202 identifies the subject data component as “a nice bridge.”

The activity data component can include data describing characteristics of the vehicle life moment, specifically, a characteristic of the subject data component. In one embodiment, the characteristic describes an interaction associated with the vehicle and the subject data component. Referring again to the illustrative example above, the vehicle life logging determination module 202 identifies the activity data component as “driving.” In this example, the activity data component describes an interaction (i.e., driving) that occurred in association with the vehicle and the subject data component.

In another embodiment, the activity data component is a location or a point-of-interest. In a further embodiment, the activity data component includes an environmental condition. Referring again to the example above, the vehicle life logging determination module 202 identifies the vehicle life logging determination module 202 identifies a second activity data component as “rain.” In this example, the activity data component describes a characteristic associated with the vehicle and the subject data component.

Once the vehicle life logging determination module 202 identifies one of the temporal data component, the subject data component and/or the activity data component from the request, the vehicle life logging I/O module 204 is configured to query the data store 120 using the temporal data component, the subject data component and/or the activity data component. The vehicle life logging I/O module 204 provides the query results to the vehicle occupant as the vehicle life moment. In one example, the vehicle life moment can be provided via the I/O module 118 and the display 130. Referring again to the illustrative example, the vehicle life logging I/O module 204 queries the data store 120 with “last year,” “a nice bridge,” “driving” and “rain.” For example, the vehicle life logging I/O module 204 may search for a point-of-interest visited last year with a geo-tag including the word “bridge.” The vehicle life logging I/O module 204 may then present location information about the bridge to the vehicle occupant via an output device (i.e. the display 130, speakers (not shown)). In one example, the I/O module 204 can respond with speech output stating, “There is the Golden Gate Bridge visited on Oct. 1, 2012.” In addition, the vehicle life moment provided to the vehicle occupant can include other media associated with the vehicle life moment, for example, photos or audio.

In one embodiment, the vehicle life moment includes personal and non-personal data. The personal and non-personal data can each be obtained from separate data sources. For example, a request from the vehicle occupant can include “Do you remember the building where my business meeting was at last week?” The temporal data component is identified as “last week,” the subject data component is “the building” and the activity data component is “business meeting.” In response, the vehicle life logging I/O module may provide the vehicle life moment as “You were at the Highland Building” based on retrieved calendar information from a portable device 128 and stored at the data store 120 and location information from the GPS 114 and stored at the data store 120.

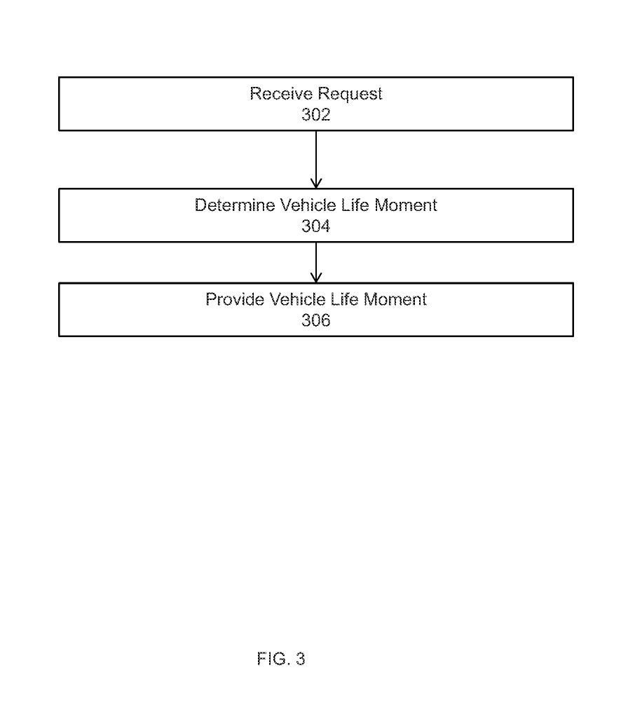

Referring now to FIG. 3, a method is shown for vehicle life logging and searching in a vehicle. The method of FIG. 3 will be described with reference to the systems and components of FIGS. 1 and 2, though it is to be appreciated that the method could be used with other systems and components. The method of FIG. 3 includes, at step 302, receiving a request for a vehicle life moment from a vehicle occupant in the vehicle. The request includes a query for a past event (i.e., a vehicle life moment) associated with the vehicle and the vehicle occupant. The request can be received via user input from the vehicle occupant and includes, but is not limited to, speech input, gesture input, text input and/or touch input.

At step 304, the method includes determining a vehicle life moment from a data store 120 based on the request. The data store 120 can include personal and non-personal data from more than one data source. By way of example, the personal data can include, but is not limited to, data about a vehicle occupant's routine, habits, appointments, calendar, social data and media data. Also by way of example, the non-personal data can include, but is not limited to, vehicle location data, vehicle diagnostic data, data about one or more vehicle systems, vehicle sensor data, environment data and weather data. The personal and non-personal data can be acquired or received from more than on data source. The data sources can include, but are not limited to, the GPS 114, the CAN 116, the networks 124, the sensors 126, the portable devices 128, applications executed by the vehicle computing device 102 and/or the portable devices 128 and the display 130. Exemplary types of personal data, non-personal data and data sources in relation to the exemplary system 100 of FIG. 1 are shown above in Table 1.

The method at step 304 also includes identifying at least one of a temporal data component, a subject data component or a temporal data component from the request. In one embodiment, the determining includes identifying the temporal data component and the subject data component. In another embodiment, the determining includes identifying the temporal data component, the subject data component and the action data component.

A temporal data component can include a time, a day, a week, a month, a year (e.g., a timestamp) associated with the activity data component. As an illustrative example, a request for a vehicle life moment can be obtained as a speech input from a vehicle occupant as “Do you remember the music playing when I was on Castro Street last week?” The vehicle life logging determination module 202 can identify the temporal data component as “last week.” The temporal data component can be converted to a date format in order to query the data store 120. For example, the vehicle life logging determination module 202 can calculate a numeric date from the temporal data component (i.e., “last week”) and the current year.

The subject data component can include data describing the subject of the vehicle life moment. In one example, the subject is the focus of the vehicle occupant's request. In other words, the subject can be the “what or whom” of the request. For example, the subject can be a location, a media file, a data file, among others. Referring again to the illustrative example above, the vehicle life logging determination module 202 identifies the subject data component as “the music.”

The activity data component can include data describing characteristics of the vehicle life moment, specifically, a characteristic of the subject data component. In one embodiment, the characteristic describes an interaction associated with the vehicle and the subject data component. Referring again to the illustrative example above, the vehicle life logging determination module 202 identifies the activity data component as “when I was on Castro Street.” In this example, the activity data component describes an interaction (i.e., driving on Castro Street) that occurred in association with the vehicle and the subject data component.

At step 306, the method includes providing the vehicle life moment to the vehicle occupant. In one embodiment, the vehicle life logging I/O module 204 is configured to query the data store 120 for the vehicle life moment using the temporal data component, the subject data component and/or the activity data component. The vehicle life logging I/O module 204 provides the query results to the vehicle occupant as the vehicle life moment. In one example, the vehicle life moment can be provided via the I/O module 118 and the display 130. Referring again to the illustrative example, the vehicle life logging I/O module 204 generates a query based on the components “last week,” “music” and “Castro Street” and execute the query on the data store 120. For example, the vehicle life logging I/O module 204 may search for a music played in the vehicle last week with a geo-tag of “Castro Street.” The vehicle life logging I/O module 204 can then present the song to the vehicle occupant via the display 130. In one example, the I/O module 204 can respond with speech output stating, “The song ‘Radioactive’ was playing.” In another embodiment, the vehicle life logging I/O module 204 can play the song via the vehicle computing device 102.

In another exemplary embodiment, the vehicle life moment can include personal and non-personal data. The personal and non-personal data can each be from separate data sources. Referring again to the illustrative example above, the song could be personal data stored or played from a portable device 128 while the location information is non-personal data acquired from the GPS 114. By providing information from different sources, the vehicle computing device 102 can provide a searchable context for memorable moments that occur in the vehicle.

The embodiments discussed herein can also be described and implemented in the context of computer-readable storage medium storing computer-executable instructions. Computer-readable storage media includes computer storage media and communication media. For example, flash memory drives, digital versatile discs (DVDs), compact discs (CDs), floppy disks, and tape cassettes. Computer-readable storage media can include volatile and nonvolatile, removable and non-removable media implemented in any method or technology for storage of information such as computer readable instructions, data structures, modules or other data. Computer-readable storage media excludes non-transitory tangible media and propagated data signals.

It will be appreciated that various implementations of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A vehicle computer implemented method for life logging and searching in a vehicle, comprising:
receiving a request from a vehicle occupant in the vehicle;
determining the vehicle life moment from a data store based on the request, wherein the determining includes identifying at least one of a temporal data component, a subject data component or an activity data component from the request; and
providing the vehicle life moment to the vehicle occupant.

2. The method of claim 1, wherein the data store includes personal and non-personal data from more than one data source.

3. The method of claim 2, wherein the data store receives and stores the personal and non-personal data when the vehicle is in an active state.

4. The method of claim 1, wherein the temporal data component is a time characteristic associated with the vehicle life moment.

5. The method of claim 1, wherein the determining includes identifying the temporal data component and the subject data component from the request.

6. The method of claim 1, wherein the determining includes identifying the temporal data component, the subject data component and the activity data component.

7. The method of claim 1, wherein the activity data component is data describing an interaction associated with the vehicle and the subject data component.

8. The method of claim 7, wherein the activity data component is an action.

9. A vehicle computing system for life logging and searching in a vehicle, comprising:
a data store communicatively coupled to a processor, the processor comprising:
a life logging determination module configured to receive a request from a vehicle occupant in the vehicle and determine a vehicle life moment from a data store based on the request, wherein the determining includes identifying at least one of a temporal data component, a subject data component or an activity data component from the request; and
a life logging input and output module configured to provide the vehicle life moment to the vehicle occupant via an output device.

10. The system of claim 9, wherein the data store includes personal and non-personal data from more than one data source.

11. The system of claim 10, wherein the life logging determination module generates a vehicle life moment record based on the personal and non-personal data when the vehicle is in an active state.

12. The system of claim 11, wherein the life logging determination module stores the vehicle life moment record in the data store.

13. The system of claim 9, wherein the activity data component is data describing an interaction associated with the vehicle and the subject data component.

14. The system of claim 9, wherein the determining includes identifying the temporal data component and the subject data component from the request.

15. The system of claim 9, wherein the determining includes identifying the temporal data component, the subject data component and the activity data component.

16. A non-transitory computer-readable storage medium storing instructions that, when executed by a vehicle computer, causes the computer to perform the steps of:
receiving a request from a vehicle occupant in the vehicle;
determining a vehicle life moment from a data store based on the request, wherein the determining includes identifying at least one of a temporal data component, a subject data component or an activity data component from the request; and
providing the vehicle life moment to the vehicle occupant.

17. The non-transitory computer-readable medium of claim 16, wherein the data store includes personal and non-personal data from more than one data source.

18. The non-transitory computer-readable medium of claim 16, wherein the data store receives and stores personal and non-personal data when the vehicle is in an active state.

19. The non-transitory computer-readable medium of claim 16, wherein the activity data component is data describing an interaction associated with the vehicle and the subject data component.

20. The non-transitory computer-readable medium of claim 19, wherein the determining includes identifying the temporal data component and the subject data component.
